(19) United States
(12) Patent Application Publication
(10) Pub. No.: US 2008/0256771 A1
(43) Pub. Date: Oct. 23, 2008

(54) Conveyor Belt and Conveyor Belt Manufacturing Process

(76) Inventors: Simon Spoors, Stockton-on-Tees (GB); Jason Podwojski, Stockton on Tees (GB)

Correspondence Address: KNOBBE MARTENS OLSON & BEAR LLP, 2040 MAIN STREET, FOURTEENTH FLOOR, IRVINE, CA, 92614, US

(21) Appl. No.: 10/569,651

(22) PCT Filed: Aug. 24, 2004
(86) PCT No.: PCT/GB2004/003617

§ 371 Date: Jul. 3, 2008

(30) Foreign Application Priority Data
Aug. 27, 2003 (GB) 0320099.5

(51) Int. Cl. B23P 11/00; B65G 15/30

(52) U.S. Cl. 29/428; 198/846

(57) ABSTRACT

The present invention relates to a process for manufacturing a conveyor belt with an image or functional element incorporated in the belt. The method comprising: manufacture of a first ply to carry an image or a functional element; applying an image or a functional element to the first ply; utilising the first ply bearing the image or functional element in the manufacture of a conveyor belt wherein the manufacturing processes involves applying a topcoat over the first ply; and joining the ends of the first ply to form an endless belt.

This invention relates to a method of manufacturing conveyor belts and conveyor belts made according to the method.

Conveyor belts are well known devices for the conveyance of goods from one point to another. They are made from sheet material, which is flexible in two directions and is jointed so as to be endless, and runs around carrying rollers and support plates. Conveyor belts are used in industrial situations (e.g. on production lines), and are almost universally present in supermarkets at their checkouts to convey goods to a till.

The potential use of a conveyor belt as an advertising medium is well known and printing information onto the top surface of a conveyor belt has been carried out previously.

However, one problem associated with known conveyor belts is that throughout its life span, objects being conveyed abrade the printed area, so that within a relatively short time the quality of the printed area becomes compromised.

A number of patent applications have been made for manufacturing processes, which incorporate printing on the upper surface of conveyor belts.

However, these processes require the belt manufacturing process to be stopped, usually after the incorporation of one or more layers of fabric and several layers of resin, and the partially manufactured belt to be sent away for printing and then returned for the next stage of the manufacturing process.

In particular, U.S. Pat. No. 4,979,591 discloses a conveyor belt having a multiple fabric layer overlaid with a thermoplastic material, such as polyvinyl chloride (PVC). Transfer printing is then used to transfer an image to the PVC layer. During this process, dye sheet contacted with the belt is locally heated to cause local sublimation of the dyestuff on the dye sheet and transfer onto the PVC layer of the belt. The applicant suggests that the resulting image on the upper surface of the belt is then covered with a film of transparent plastic protecting the belt and the transfer printed image from abrasion. However no suitable material for the protecting layer is identified in U.S. Pat. No. 4,979,591. Furthermore, the type of transfer printing disclosed in U.S. Pat. No. 4,979,591 is not ideal, as it tends to result in diffuse images. Transfer printing also suffers from a restricted availability of colours.

WO 97/43125 discloses the application of silk-screen printing directly on to a PVC substrate. The technique disclosed therein allows the formation of an image of far greater resolution than obtainable by transfer printing. The inks forming the image are made to adhere to the PVC substrate by blowing air over it at about 80 degrees Centigrade for approximately 15 seconds and then applying a coat of clear PVC varnish.

In both of these publications, the image is formed on the belts at a late stage in their manufacture when the full thickness of the belt, with several layers of fabric and resin, has been reached. Consequently, if the overall thickness of the belt is to be kept similar to existing belts (in order that existing equipment for conveyors can be used), only a thin layer of clear coating can be applied to protect the printed surface. This is not always satisfactory as abrasion caused by the goods being transported leads to the printed surface having a short life before it becomes difficult to read.

To overcome the problem of the printed conveyor belt being thicker than one without printing, in WO 00/69759 the partially manufactured belt is removed at an earlier stage in the manufacturing process than in the abovementioned art, and sent to silk screen printers for printing. On returning the partially completed printed belt to the manufacturing process, 4 or 5 layers of PVC, in the form of a transparent thermosetting material, are incorporated to bring the belt up to the thickness of a conventional unprinted conveyor belt. The 4 or 5 layers of PVC, in the form of a transparent thermosetting material, provide far greater protection than found in the previous belts manufactured according to U.S. Pat. No. 4,979,591 or WO 00/69759, whilst the belt retains the thickness of conventional, unprinted conveyor belts. The disadvantage of this process is that the belt manufacturing process has to be interrupted part way through manufacture and the bulky partially completed belt needs to be handled onto a silk screen printer where it is printed in short increments before being returned to the belt manufacturer to complete manufacture.

It is an object of the present invention to provide improvements in conveyor belt manufacture.

According to a first aspect of the invention there is provided a process for manufacturing conveyor belts with an image or functional element incorporated in the belt, the method comprising:
(1) manufacture of a first ply adapted to carry an image or a functional element;
(2) applying an image or a functional element to the first ply;
(3) utilising the first ply bearing the image or functional element in the manufacture of a conveyor belt wherein the manufacturing processes involves applying a topcoat over the first ply; and
(4) joining the ends of the first ply to form an endless belt.

The method according to the first aspect of the invention differs substantially from WO 00/69759, as it uses a first ply which may be pre-printed with any combination of images or prefabricated with functional elements. Such plies are created in advance of conveyor belt manufacture and the ply is then used in the manufacture of a conveyor belt without the need to modify the belt manufacturing process. The end result is a standard construction belt carrying an image or functional element without any protective polymers/varnishes applied as described in U.S. Pat. No. 4,979,591 or any secondary coats of polymers as described in patent WO 00/69759.

There are therefore no unnecessary changes in the belt manufacturing process using the present invention. The belts are constructed without adding any form of text or images to either a partly or wholly completed belt in a two-stage process of lamination as detailed in WO 00/69759.

According to a preferred embodiment of the first aspect of the present invention the first ply may be a blend of yarns and fibres such as silk, nylon, cotton, rayon or polyester yarn which confers strength and stability to the conveyor belt. Spun polyester may also be employed as its “hairy texture” has the particular advantage of reduced noise during use of the conveyor belt.

In a further embodiment of the first aspect of the present invention, the first ply may be a fine woven fabric, yet different types of material including knitted fabric and non-woven textile may also be used. Most preferably, the first ply may be a conventional polyester ply for use in the construction of a conveyor belt.

Alternatively, the first ply may be formed from a variety of different media. Such media include film laminate, acetate, paper and foil.

According to a preferred method of the first aspect of the present invention, the first ply may be pre-printed with any combination of images or prefabricated with any combination of functional elements such as metal strips, barcodes or magnetically retrievable information in advance of conveyor belt manufacture. Once prepared, the first ply may be used to construct a conveyor belt.

When the first ply bears an advertisement or other image, the printed text and images may be produced using Desktop publishing technology. This can allow images from 1 centimetre to 100 metres without any breaks.

The printing of advertisements or other images onto the first ply may be performed using any type of printing technique. However preferred methods comprise transfer printing, silk screen or laser printing or, more preferably roll to roll inkjet printing (e.g. a roll-through printer (such as a wide format digital printer), comparable to regular ink jet printers as used in the clothing industry).

The inkjet printing may be in 24 million colours at resolutions of 300 dpi or more (e.g. 720 dpi). This allows a quality of printing normally only seen in printed magazines. Preferred inks are light, water fast and resist high temperatures, as they may be subjected to higher temperatures in the conveyor belt manufacturing process.

High-speed printing allows for mass production of the highest quality of printed first plies. Some modifications of the printer's feeder unit may be required to enable printing continuously from roll to roll of the first ply.

After a roll of first ply material is printed upon, the image may be fixed through heating and washing should the material of the first ply require it.

The choice of material for the first ply may necessitate the treatment of the ply prior to the printing process to improve the quality of the print. This may involve the addition of one or further specific coatings facilitating the adhesion of inks used throughout the printing process and/or to provide dimensional stability.

One of the main differences between existing methods of conveyor belt manufacture and the methods encompassed by the present invention lies in the use of advanced printing technologies such as digital printing technology. Thus, the main advantage of the present invention is its practicality in that the use of such advanced printing technologies allows the production of great lengths of a first ply which may comprise several different designs (arranged in linear or parallel fashion) which can be produced and cut to size as required prior to conveyor belt manufacture.

The topcoat may be applied to the first ply by a variety of coating/impregnating/dipping processes.

It is preferred that the topcoat is applied to the desired thickness on one or both sides of the ply. Preferably, topcoats such as PVC may be applied by dipping or spreading or by melt processing (calandering/extrusion). Others such as thermoplastic polyurethane (TPU) must be applied by using solvent or water-based liquids or more commonly by melt processing (calandering/extrusion/powder sintering). Others such as Polyolefin's must be applied by melt processing. In principle, any thermoplastic material and many rubbers can be used to make conveyor belting, yet the wear/flex properties of PVC and TPU are preferred.

The topcoat agent for use in the present invention may be any adhesive, yet in a preferred embodiment the coating agent is PVC or PU, and mostly preferred PU. PU has the following structure and is available to those skilled in the art.

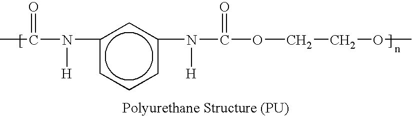

Conventional manufacturing processes use coloured topcoats that are rendered opaque by the addition of suitable pigments like carbon powder for black-coloured belts. It will be appreciated that, in the context of the present invention, topcoats coating the first ply need to be transparent to allow an image on the first ply to be visible. This is easily achieved since coating agents (such as PU) may be supplied without colouring. In fact during manufacture of conventional conveyor belts colour is added to agents such as PU. In the light of the present invention, it is advised to omit the colouring step in conveyor belt manufacture so as to create a desirable transparent surface.

In a preferred embodiment of the present invention, a desirable matt finish for conveyor belts may be achieved by mechanically texturing the top surface of the conveyor belts whilst the material is still soft.

The clear topcoat may be composed of polymers like PU or PVC which produce non-reflective surfaces. This may also be achieved by mechanical texturing.

The conveyor belt may be made endless by fusion of the joint. In a preferred embodiment this may be achieved by pressing the joint in a heated/cooled press. The joint may be formed by cutting “fingers” into the end of the ply and interlinking the fingers to form a joint. The joint may be sealed by means of an adhesive or by heat treatment.

It will be appreciated that one of the benefits of the present invention is that conventional belt manufacturing processes may be used. Such processes are familiar to one skilled in the art.

A typical procedure for manufacturing conveyor belts comprises the use of tension adjusting rolls, guide rolls, pressure rolls, bonding agent applicators and topcoat applicators.

Throughout all stages of the manufacturing process of the conveyor belt according to the present invention, the tension of the various layers of plies may be adapted by passing them over tension adjusting rolls before they may be passed over one or more sets of guide rolls and brought together.

Furthermore, pressure rolls may be mounted in front of the topcoat applicator to bring the components together firmly enough in order to prevent air from being caught between layers thereby minimising the formation of blisters at a later stage.

The production process of single ply conveyor belts according to the present invention permits printing directly onto the fabric, allowing the initial steps of conveyor belt manufacture including the printing of an image to be completed away from the conveyor belt manufacture site prior to initiation of the actual conveyor belt manufacturing process.

A roll of first ply material (carrying an image or functional element) is provided to the conveyor belt manufacturer following the printing process. Subsequently, at least one clear topcoat consisting of one or several protective layers may be applied on top of the printed image followed by conventional steps of the production process until completion of the conveyor belt.

In the end, the surface of the completed belt receives its finish. This may be achieved by various means including mechanical techniques such as embossing. The finished conveyor belt may then be wound up on a take up reel using an appropriate motorised rotating device and prepared for transportation.

It will be appreciated that the methods encompassed by the present invention also provide for the manufacture of multi-ply conveyor belts. Consisting of a first ply and at least one further ply, such multi-ply conveyor belts may be produced in a way similar to single-ply conveyor belts with the addition of the coated first ply being laminated on top of at least one prepared further ply consisting of fabric and coating.

The material of further plies may be identical to the material of the first ply (e.g. polyester yarn), yet different materials known to those skilled in the art may also be used. It will be appreciated that further plies may also be printed upon so as to produce double-sided belts. However, in a preferred embodiment of the present invention further plies may be composed of plain ply material conferring strength and stability to the belt. Such further plies may comprise the same materials as mentioned above with regards to first plies. In an additional embodiment of the present invention, the material of further plies may be treated (e.g. coated) according to functional requirements prior to their joining together.

The joining of plies may be achieved with the use of bonding agents or appropriate heat treatment. The bonding agents for use in the present invention may be any adhesive, yet in a preferred embodiment coating agents as described above may be used as bonding agents (e.g. PVC or PU, mostly preferred PU).

According to a second aspect of the present invention there is provided a conveyor belt made according to the method of the first aspect of the invention.

The invention will now be further described by way of illustrative example and with reference to the accompanying drawings, in which:

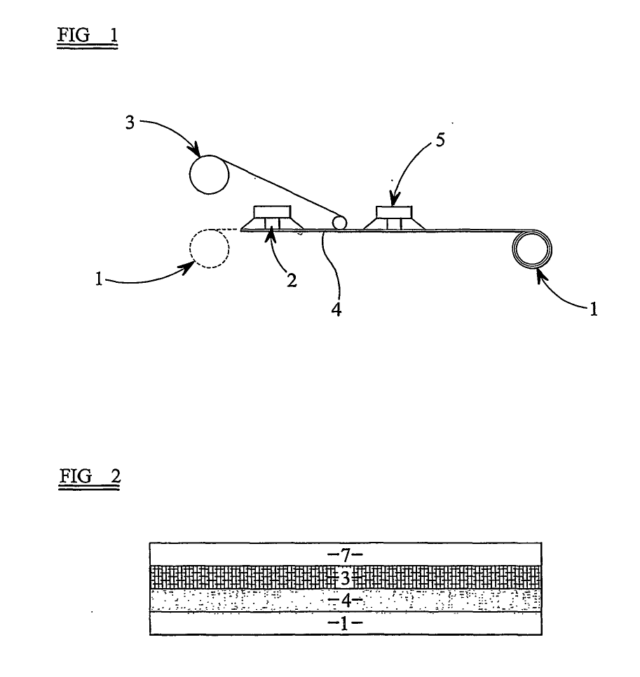

FIG. 1 shows diagrammatically the manufacturing process for inserting a pre-printed first ply in the construction of conveyor belts;

FIG. 2 shows an example of a “two-ply” conveyor belt using a pre-printed first ply;

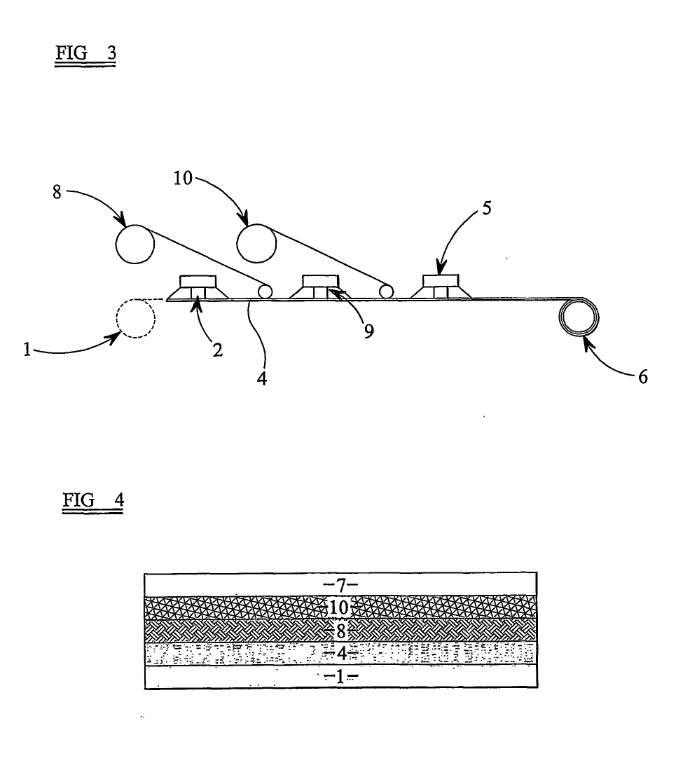

FIG. 3 shows the manufacturing process for inserting a pre-printed first ply in addition to the two existing woven polyester plies in the construction of conveyor belts;

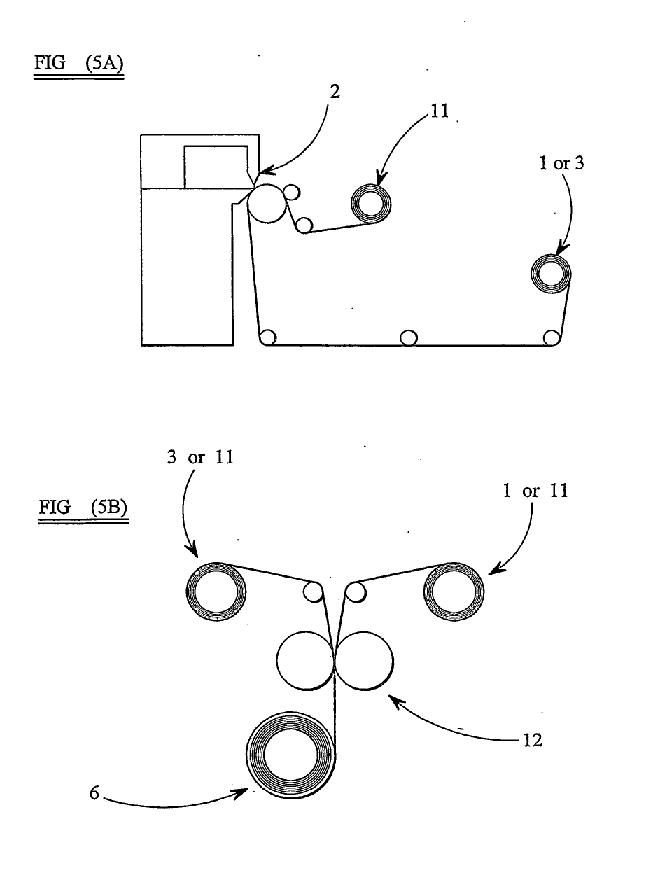

FIG. 4 shows an example of a “multi-ply” conveyor belt comprising a first ply insert in addition to the two existing polyester plies of “two-ply” conveyor belts; and

FIG. 5 illustrates a preferred method of manufacturing a two ply conveyor belt according to the present invention: (A) illustrates a first stage of belt manufacture involving the coating of a ply (this may be a first ply and/or a further ply); and (B) a second stage involving the bonding of coated plies together to form a 2 ply belt.

A “two-ply” conveyor belt may be manufactured according to the present invention. Referring to FIG. 1, a further ply 1 according to the invention made of a woven polyester material, is processed through a PU bond applicator 2 following which a pre printed first ply 3 consisting of woven polyester fabric bearing an inkjet produced image is placed onto the PU bond 4. A clear PU top cover applicator 5 then adds a clear layer of PU onto the pre printed first ply 3 thereby producing a finished media belt 6.

FIG. 2 shows a cross section through the finished media belt where the polyester-based further ply 1 is covered by a middle PU bond 4. The pre printed media ply 3 overlays the middle PU bond 4 and is covered by a clear PU top cover 7.

According to a further embodiment of the present invention a “multi-ply” conveyor belt may be manufactured. Referring to FIG. 3, a further ply 1 made of a woven polyester material is processed through a PU bond applicator 2 following which a second polyester ply 8 is placed onto the PU bond 4. Following a second PU bond applicator 9 a pre printed first ply 10 is applied to the belt and a clear layer of PU is added onto the pre printed media laminate 10 by PU top cover applicator 5 which thereby produces a finished media belt 6.

FIG. 4 shows a cross section through the finished media belt comprising a polyester-based further ply 1 which is covered by a middle PU bond 4 and a second polyester ply 8 overlaying the middle PU bond 4 which is covered by a pre printed first ply 10. The first ply 10 itself is covered by a clear PU top cover 7.

In a further embodiment of the present invention, a weigh belt may preferably control the speed of the conveyor belt assembly throughout the process of manufacture.

FIG. 5 illustrates a preferred method of manufacturing a two ply conveyor belt according to the present invention. In FIG. 5(A) illustrates a first stage of belt manufacture involving the coating of a ply (this may be a first ply 3 and/or a further ply 1) (e.g. an untreated polyester fabric) with a suitable coating to form a coated ply 11. The first ply 3 may then have an image printed on it as described above. The first ply 3 (which may be coated 11) and at least one further ply 1 (which may be coated 11) are then bonded together (e.g. by use of heat treatment device 12), as illustrated in FIG. 5((B) to form a “2 ply belt” 6 according to the invention.

1. A process for manufacturing a conveyor belt with an image or functional element incorporated in the belt, the process comprising:
(1) the manufacture of a first ply to carry an image or a functional element;
(2) applying an image or a functional element to the first ply;
(3) utilising the first ply bearing the image or functional element in the manufacture of a conveyor belt wherein the manufacturing processes involves applying a topcoat over the first ply; and
(4) joining the ends of the first ply to form an endless belt.

2. The process according to claim 1 wherein the first ply comprises a blend of yarns or fibres.

3. The process according to claim 2 wherein the blend of yarns or fibres is silk, nylon, cotton or rayon.

4. The process according to claim 1 wherein the first ply comprises a woven fabric of polyester.

5. The process according to claim 1 wherein the first ply is a film laminate, acetate, paper or foil.

6. The process according to claim 1 wherein the first ply bears a printed image.

7. The process according to claim 6 wherein the image is printed on to the first ply by silk screen printing, laser printing or inkjet printing prior to belt manufacture.

8. The process according to claim 1 wherein the first ply bears functional elements.

9. The process according to claim 8 wherein the functional element is a metal strip, barcode or magnetically retrievable information.

10. The process according to claim 1 wherein the topcoat is Polyurethane (PU) or Polyvinylchloride (PVC).

11. The process according to claim 1 wherein a further ply is incorporated into the belt.

12. The process according to claim 11 wherein the further ply comprises a blend of yarns or fibres.

13. The process according to claim 12 wherein the blend of yarns or fibres is silk, nylon, cotton or rayon.

14. The process according to claim 11 wherein the further ply comprises a woven fabric of polyester.

15. The process according to claim 11 wherein the further ply is a film laminate, acetate, paper or foil.

16. The process according to claim 11 wherein the first ply and the further ply are bonded to each other using a bonding agent.

17. The process according to claim 11 wherein the bonding agent is any adhesive.

18. The process according to claim 11 wherein the bonding agent is PVC or PU.

19. A conveyor belt manufactured according to the process defined by claim 1.
